(19) United States
(12) Patent Application Publication
(10) Pub. No.: US 2026/0219104 A1
(43) Pub. Date: Jul. 30, 2026

(54) ADJUSTMENT METHOD, ADJUSTMENT SYSTEM AND LASER BEAM UNIT

(71) Applicant: TRUMPF LASERSYSTEMS FOR SEMICONDUCTOR MANUFACTURING SE, Ditzingen (DE)

(72) Inventor: Tom BOLZE, Stuttgart (DE)

(21) Appl. No.: 19/630,493

(22) Filed: Mar. 27, 2026

Related U.S. Application Data
(63) Continuation of application No. PCT/EP2024/078574, filed on Oct. 10, 2024.

(30) Foreign Application Priority Data
Oct. 12, 2023 (DE) 10 2023 127 853.3

(51) Int. Cl. G01J 1/42; G01J 1/04; G02B 27/09

(52) U.S. Cl. CPC G01J 1/4257; G02B 27/0927; G01J 1/0411

(57) ABSTRACT

A method for adjusting a beam caustic of a laser beam generated by a laser beam unit is provided. The laser beam unit includes an optical device. The method includes ascertaining three beam diameters of the laser beam at three measurement planes positioned along a laser beam propagation direction, determining the beam caustic of the laser beam by analytically calculating beam propagation parameters of the laser beam based on the three ascertained beam diameters, ascertaining a laser beam deviation by comparing the beam caustic with a target beam caustic of the laser beam, and adjusting the laser beam unit based on the ascertained laser beam deviation.

### CROSS REFERENCE TO RELATED APPLICATIONS

This application is a continuation of International Application No. PCT/EP2024/078574 (WO 2025/078531 A1), filed on Oct. 10, 2024, and claims benefit to German Patent Application No. DE 10 2023 127 853.3, filed on Oct. 12, 2023. The aforementioned applications are hereby incorporated by reference herein.

### FIELD

Embodiments of the present invention relate to an adjustment method for adjusting a beam caustic of a laser beam of a laser beam unit having an optical device. Embodiments of the present invention also relate to an adjustment system and a laser beam unit.

### BACKGROUND

Laser beam units are used in many different ways. A special application for laser beam units is the generation of extreme ultraviolet radiation (EUV radiation). In this process, a suitable material, in particular a tin droplet, is exposed to a laser beam so that the desired EUV radiation is generated. Laser beam units for generating EUV radiation are used, for example, for the production of semiconductors.

In the case of laser beam units, in particular for generating EUV, it must be ensured that the laser beam unit and in particular the laser beam of the laser beam unit meet the predetermined specifications before it is used as intended. These specifications can include safety-related factors or factors that determine the quality and performance of the laser beam.

In order to ensure this intended state of the laser beam unit or the laser beam, the beam caustic of the laser beam is typically measured and evaluated. If the beam caustic is not within the predetermined specification, the optical device on the laser system is usually adjusted or replaced. It is usually necessary to measure the beam caustic and correct the optical device several times before the specifications are met and the laser can be used for its intended purpose.

Conventional methods specify detecting the laser beam using multiple cameras at multiple predetermined points along the beam axis. In this context, the cameras are typically directed directly into the laser beam. In practice, camera images are usually detected at a minimum of nine, often up to fourteen predetermined positions. The beam caustic is then determined from the camera images using statistical methods, in particular by means of a fitting function.

This method, known from the prior art, has the disadvantage that a large number of measurements have to be taken at different positions of the laser beam. This constitutes a considerable measurement effort. In addition, it is often necessary to repeat the measurement multiple times in order to adjust the optical device, which further increases the measurement effort.

In addition, the measuring positions of the laser beam are typically predetermined and cannot be changed without affecting the statistical evaluation. Particularly in hard-to-reach areas of the laser system, measurements can therefore only be carried out if the system is partially dismantled and then reassembled. This further increases the measurement effort and therefore the time and costs involved.

### SUMMARY

Embodiments of the present invention provide a method for adjusting a beam caustic of a laser beam generated by a laser beam unit. The laser beam unit includes an optical device. The method includes ascertaining three beam diameters of the laser beam at three measurement planes positioned along a laser beam propagation direction, determining the beam caustic of the laser beam by analytically calculating beam propagation parameters of the laser beam based on the three ascertained beam diameters, ascertaining a laser beam deviation by comparing the beam caustic with a target beam caustic of the laser beam, and adjusting the laser beam unit based on the ascertained laser beam deviation.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an adjustment method for adjusting the beam caustic of a laser beam unit, according to some embodiments;

FIG. 2 shows a schematic representation of a laser beam unit with a laser beam propagating in the laser beam propagation direction, according to some embodiments;

FIG. 3 shows a schematic representation of a first embodiment of a laser beam unit with an adjustment system, according to some embodiments; and

FIG. 4 shows a schematic representation of a second embodiment of a laser beam unit with an adjustment system, according to some embodiments.

### DETAILED DESCRIPTION

Embodiments of the invention provide a method and a device for reliably and quickly adjusting and using a laser beam unit.

According to some embodiments, an adjustment method is configured to adjust the beam caustic of a laser beam of a laser beam unit. In particular, the laser beam unit is configured for generating extreme ultraviolet radiation (EUV radiation) by irradiating a suitable material, for example a drop of tin. The laser beam unit typically has an optical device for generating the laser beam. Preferably, the adjustment method is designed to adjust the optical device. This allows for a particularly effective adjustment to be made to the laser beam unit.

The laser beam can be designed as a single beam and/or in the form of sub-beams. Sub-beams can be split in particular by means of beam splitters. Such sub-beams can serve as measurement beams for measurement and evaluation tasks, while another sub-beam is used as intended, in particular for generating extreme ultraviolet radiation.

The adjustment method is particularly suitable for checking an optical device that has already been configured. The configured optical device is typically designed to form an approximate beam caustic of the laser beam. In other words, the adjustment method is particularly suitable for fine adjustment of the laser beam unit.

The adjustment method has the following method steps:

In a method step a) of the adjustment method, it is provided to ascertain three beam diameters of the laser beam at three measurement planes positioned along the laser beam propagation direction. In other words, the radial extension of the laser beam in relation to the laser beam propagation direction is detected at three different measuring positions. In particular, the positions of the measurement planes can be freely determined along the laser beam propagation direction. This allows the position of the measurement planes to be determined on the basis of the accessibility of a particular position, for example. This allows measurements to be carried out even more quickly and easily, as there is no need to dismantle the laser beam unit, for example.

Preferably, a maximum of three beam diameters are detected on a maximum of three measurement planes. This considerably reduces the metrological effort involved in detecting the beam diameters compared to the known methods. In addition, the detected beam diameters can be processed more quickly, which can significantly accelerate the process speed of the adjustment method.

A subsequent method step b) of the adjustment method provides for determining the beam caustic of the laser beam by analytically calculating at least one beam propagation parameter of the laser beam on the basis of the three ascertained beam diameters. Preferably two or more, in particular all necessary, beam propagation parameters are calculated in order to determine the beam caustic. As the number of calculated beam propagation parameters increases, the accuracy in determining the beam caustic can be improved.

Beam propagation parameters include, but are not limited to, the focal position of the laser beam, a waist diameter of the laser beam, a divergence angle of the laser beam, a Rayleigh length and/or a diffraction index of the laser beam.

In a method step c) of the adjustment method, it is provided to ascertain a laser beam deviation by comparing the determined beam caustic with a target beam caustic of the laser beam. By comparing the actual beam caustic and the target beam caustic, deviations in the adjustment of the laser beam unit, in particular the optical device, can be ascertained. Furthermore, operational signs of wear on the laser beam unit can be detected.

The target beam caustic is to be understood as a predetermined beam propagation in the laser beam propagation direction that is optimized for the operation and configuration of the laser beam unit. The target beam caustic is typically defined before the laser beam unit is operated, or the laser beam unit is adjusted to form the target beam caustic.

In a subsequent method step d) of the adjustment method, the laser beam unit, in particular the optical device, is adjusted on the basis of the ascertained laser beam deviation. In other words, the laser beam unit, in particular the optical device, is adjusted in order to match the beam caustic of the laser beam to the target beam caustic. Preferably, the beam caustic corresponds to the target beam caustic after adjustment.

Preferably, the focal position is changed when adjusting the laser beam unit, which allows the performance of the laser beam unit to be kept high, in particular when generating EUV radiation.

Alternatively or additionally, when adjusting the laser beam unit, it can be provided that worn and/or damaged components of the laser beam unit are serviced or replaced. In addition, it can be provided that scheduled maintenance takes place earlier in order to ensure smooth operation.

As described above, embodiments of the invention relate to a new method for determining the beam caustic of the laser beam. The adjustment method makes it particularly easy to detect the process-relevant beam diameters for determining the beam caustic. This saves a considerable amount of time when setting up and commissioning the laser beam unit. Due to the reduced metrological effort for detecting only three beam diameters, the adjustment method can be carried out using measurement technology integrated into the laser beam unit. The considerably reduced detection effort with respect to the beam diameters also results in particularly fast further processing and thus fast determination of the beam caustic, which enables a particularly fast reaction to any deviations detected. This makes the adjustment method according to embodiments of the invention suitable for real-time monitoring of a laser beam unit. An automatic or machine-controlled adjustment, for example of the focal position, can be used to adjust to changing operating conditions in real time, further improving the effectiveness of the laser beam unit.

In a preferred embodiment of the adjustment method, in step a) a far-field beam diameter of the laser beam is ascertained at a first measurement plane positioned in the far field of the laser beam. The far field is understood to be a region at a distance from the focal position of the laser beam along the laser beam propagation direction, in which the beam cross-section of the laser beam increases linearly with the distance from the focal position. Typically, in step b), a the divergence angle of the laser beam is determined by the far-field beam diameter. This means that a single measurement can be used to determine a beam propagation parameter that is crucial for determining the beam caustic.

In order to determine the divergence angle, it can be provided that an apparatus lens with a predetermined focal length is arranged in the beam path of the laser beam in front of the first measurement plane. This allows the divergence angle to be determined according to the following formula, for example:

$$θ = \frac{{w}_{1}}{f}$$

According to the exemplary formula, θ is the divergence angle, w₁ is the far-field beam diameter and f is the focal length of the apparatus lens.

Alternatively or additionally, it can be provided, for example, that the divergence angle is determined by means of trigonometric relationships of the far-field beam diameter at the first measurement plane and a second far-field beam diameter at an auxiliary plane. The auxiliary plane can be created, for example, by moving the first measurement plane in the laser beam propagation direction. According to this embodiment, the adjustment method can be carried out with only four measurement planes.

A preferred further development of the adjustment method is one in which, in step a), a first near-field beam diameter is ascertained at a first measurement plane positioned in the near field of the laser beam and a second near-field beam diameter is ascertained at a second measurement plane positioned in the near field. The near field is understood to be a region along the laser beam propagation direction in which the beam cross-section does not change linearly on the basis of the laser beam propagation direction. Typically, the near field extends along the laser beam propagation direction in a range of +/−the Rayleigh length around the focal position. Typically, a focal position is determined in step b). When determining the focal position, the position of the first measurement plane, the position of the second measurement plane, the first near-field beam diameter, the second near-field beam diameter and the divergence angle are taken into account. Knowledge of the focal position allows for an even more precise adjustment of the laser beam unit, in particular the optical device.

For example, the focal position can be determined according to the following formula:

$${z}_{0} = \frac{{w}_{1}^{2} - {w}_{2}^{2} + {θ}^{2} ( {z}_{2}^{2} - {z}_{1}^{2} )}{2 {θ}^{2} ( {z}_{2} - {z}_{1} )}$$

According to the exemplary formula, z₀ is the focal position, w₁ is a first beam cross-section, w₂ is a second beam cross-section, z₁ is a first measurement plane position, z₂ is a second measurement plane position and θ is the divergence angle.

A further development of the adjustment method in which a waist diameter is determined in step b) is also preferred. The waist diameter can be understood as the diameter of the laser beam at the focal position. When calculating the waist diameter, the focal position, the position of the first measurement plane and the diameter of the first near-field beam diameter are typically taken into account. In this way, the adjustment of the laser beam unit can be further improved.

For example, the waist diameter can be determined according to the following formula:

$${w}_{0} = \sqrt{{w}^{2} - {{θ}^{2} ( z - {z}_{0} )}^{2}}$$

According to the exemplary formula, w₀ is the waist diameter, w is a beam cross-section, z is a measurement plane position, z₀ is the focal position and θ is the divergence angle.

A further development of the adjustment method in which a Rayleigh length and/or a diffraction index is determined in step b) is also preferred. When calculating the Rayleigh length and/or the diffraction index, the waist diameter and the divergence angle are typically taken into account. The beam caustic can be determined completely by calculating the Rayleigh length and the diffraction index. This enables the beam caustic of the laser beam to be fully predicted.

For example, the Rayleigh length can be determined according to the following formula:

$${z}_{R} = \frac{π {w}_{0}^{2}}{{M}^{2} λ} = \frac{{w}_{0}}{θ}$$

According to the exemplary formula, Z_{R} is the Rayleigh length, w₀ is the waist diameter, θ is the divergence angle, λ is the wavelength and M is the diffraction index.

For example, the diffraction index can be determined according to the following formula:

$${M}^{2} = \frac{θπ {w}_{0}}{λ}$$

According to the exemplary formula, M is the diffraction index, λ is the wavelength, w₀ is the waist diameter and θ is the divergence angle.

In a preferred further development of the adjustment method, in step a) the second near-field beam diameter is determined spaced apart from the first near-field beam diameter by a near-field measurement plane distance between the first measurement plane and the second measurement plane. In other words, the first near-field beam diameter is determined at a local distance from the second near-field beam diameter. This avoids inaccuracies in determining the beam caustic, which can occur if the distance between the first measurement plane and the second measurement plane is too small.

A further development of the adjustment method in which the first measurement plane is positioned in front of the focal position in the laser beam propagation direction is preferred. In other words, the first measurement plane is located upstream of the focal position in the laser beam propagation direction. The first measurement plane is therefore positioned in a region of the laser beam with a beam cross-section that tapers in the laser beam propagation direction. This can increase the accuracy and robustness of the adjustment method.

A further development of the adjustment method in which the second measurement plane is positioned behind the focal position in the laser beam propagation direction is also preferred. In other words, the second measurement plane is located downstream of the focal position in the laser beam propagation direction. The second measurement plane is therefore positioned in a region of the laser beam with a beam cross-section which widens in the laser beam propagation direction. This can further increase the accuracy and robustness of the adjustment method.

In a preferred embodiment of the adjustment method, at least one of the beam diameters, in particular all beam diameters, is/are determined by graphical evaluation of a representation of the laser beam cross-section. Preferably, the representation is created by image-producing apparatuses, in particular cameras and/or photodiodes. The method of graphical evaluation has proven to be particularly reliable and fast for determining the beam caustic.

Preferably, the representations of the laser beam cross-section are created and evaluated at a frequency of more than 50 Hz, particularly preferably more than 100 Hz. This ensures particularly effective real-time monitoring.

Embodiments of the invention also provide an adjustment system.

The adjustment system is designed and configured for adjusting a laser beam unit, in particular an optical device of the laser beam unit. In particular, the adjustment system is configured to carry out the adjustment method described above and below.

The adjustment system is designed to determine multiple beam diameters along the laser beam propagation direction of the laser beam of the laser beam unit. In other words, the adjustment system has at least the following components.

The adjustment system has at least one image-producing apparatus. The image-producing apparatus is designed in particular as a camera and/or a photodiode. The image-producing apparatus is designed for detecting the beam diameter of the laser beam. The image-producing apparatus can be positioned in the immediate vicinity and/or in the beam path of the laser beam. The image-producing apparatus is designed for at least temporary positioning in the beam path of the laser beam.

The adjustment system also has a computing unit. The computing unit is designed and configured to determine the beam caustic from the detected beam diameters and to determine a laser beam deviation by comparing the beam caustic with a target beam caustic.

The adjustment system also comprises an output unit. The output unit is designed and configured to output the determined laser beam deviation, in particular graphically. In other words, the output unit is designed to output results from the computing unit. The output unit can be designed as a display of the adjustment system.

A preferred embodiment of the adjustment system has two, in particular three, image-producing apparatuses. Preferably, at least one of the image-producing apparatuses, in particular all image-producing apparatuses, is/are designed to be positionable in a stationary manner on the beam path and/or in the beam path of the laser beam of the laser beam unit. The stationary arrangement of the image-producing apparatus means that it can remain arranged in a region of the laser beam unit that is difficult to access. This eliminates the need for time-consuming dismantling and reassembly of the laser beam unit.

Embodiments of the invention also provide a laser beam unit.

The laser beam unit has an optical device for outputting a laser beam and the adjustment system described above and below. The optical device typically comprises multiple optical components and/or optical function groups, which are designed to produce a predetermined target beam caustic of the laser beam.

The laser beam unit is preferably designed and configured for targeted irradiation of a target material for generating extreme ultraviolet radiation (EUV radiation).

Further advantages of the embodiments of the invention are evident from the description and the drawing. Similarly, the features mentioned above and the features still to be explained may each be used on their own or together in any desired combinations according to various embodiments.

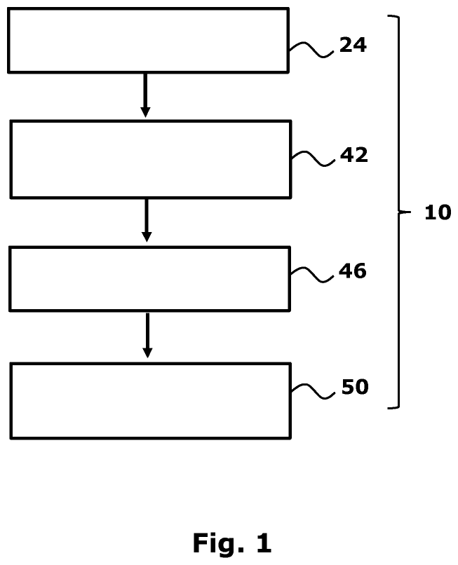

FIG. 1 shows a schematic representation of an adjustment method 10. The adjustment method 10 is explained below with reference to the other figures in the drawing.

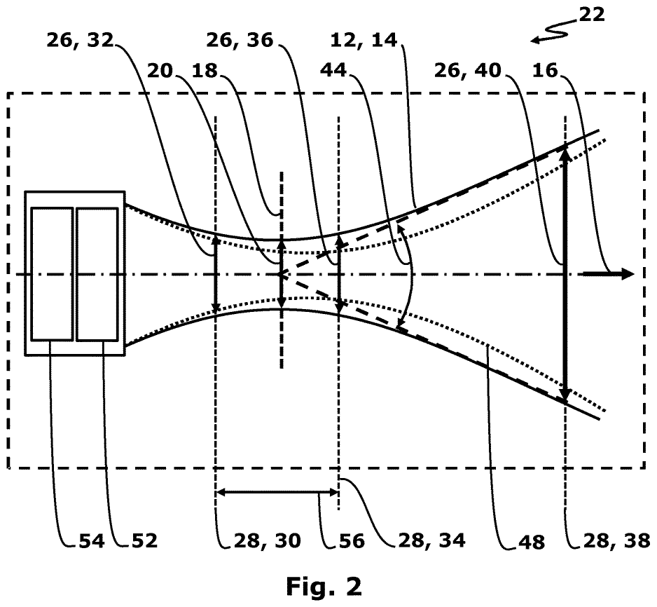

The adjustment method 10 is designed to adjust a beam caustic 12 (see FIGS. 2, 3 and 4) of a laser beam 14 (see FIGS. 2, 3 and 4). The beam caustic 12 refers to the propagation or diameter change of the laser beam 14 in the laser beam propagation direction 16 (see FIGS. 2, 3 and 4). The beam caustic 12 typically defines characteristic properties of the laser beam 14, for example a focal position 18 (see FIG. 2) and/or a waist diameter 20 (see FIG. 2).

Adjusting the beam caustic 12 of the laser beam 14 is of considerable importance for the effectiveness of a laser beam unit 22 (see FIGS. 2, 3 and 4). In particular for generating extreme ultraviolet radiation (EUV radiation), in which the laser beam 14 is directed onto a target material (not shown), for example a tin droplet, the precise determination and adjustment of the beam caustic 12, in particular the focal position 18, is crucial for a successful process.

The adjustment method 10 includes at least the following method steps:

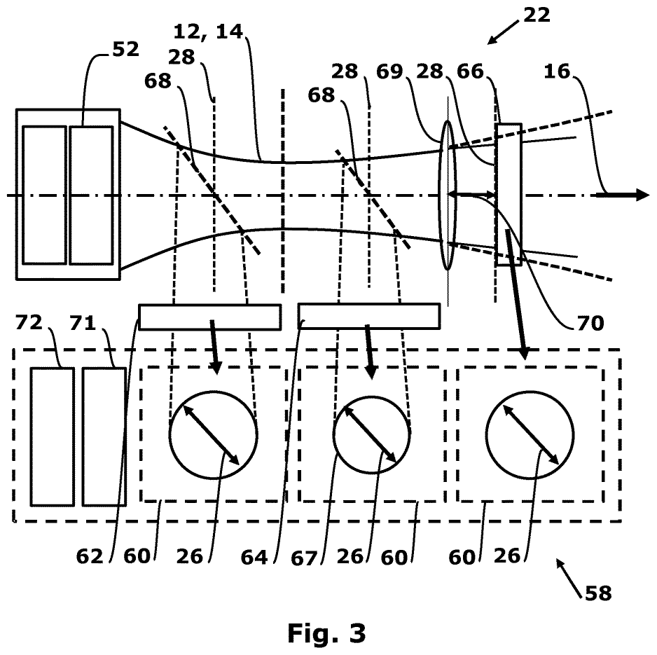

In a first method step 24 of the adjustment method 10, it is provided to ascertain three beam diameters 26 (see FIGS. 2, 3 and 4) of the laser beam 14 at three measurement planes 28 positioned along the laser beam propagation direction 16 (see FIGS. 2 and 3).

As shown in FIG. 2, one of the measurement planes 28 can be positioned as a first measurement plane 30 (see FIG. 2) in the near field of the laser beam 14, whereby one of the beam diameters 26 can be determined as a first near-field beam diameter 32 (see FIG. 2).

Preferably, a further one of the measurement planes 28 is positioned as a second measurement plane 34 (see FIG. 2) in the near field of the laser beam 14, whereby a further one of the beam diameters 26 can be determined as a second near-field beam diameter 36 (see FIG. 2).

Alternatively or additionally, one of the measurement planes 28, as shown in FIG. 2, is preferably positioned as a third measurement plane 38 (see FIG. 2) in the far field of the laser beam 14, whereby a beam diameter 26 can be determined as a far-field beam diameter 40 (see FIG. 2).

A further method step 42 of the adjustment method 10 provides for determining the beam caustic 12 of the laser beam 14 by analytically calculating beam propagation parameters of the laser beam 14 on the basis of the three ascertained beam diameters 26.

Typical beam propagation parameters can be, for example, the focal position 18, the waist diameter 20, a divergence angle 44 (see FIG. 2) of the laser beam 14, a Rayleigh length (not shown) and/or a diffraction index (not shown). This list is not intended to be exhaustive.

In a preferred embodiment of the adjustment method 10, it can be provided that the far-field beam diameter 40 is determined in the method step 24. By knowing the far-field beam diameter 40, the divergence angle 44 can be calculated. This allows the further calculation of beam propagation parameters to be carried out more accurately.

In a preferred embodiment of the adjustment method 10, it can further be provided that the first near-field beam diameter 32 is determined in the method step 24. By knowing the near-field beam diameter 32 and knowing or assuming the focal position 18, the waist diameter 20 can be determined, for example.

In the method step 24, it can alternatively or additionally be provided that the second near-field beam diameter 36 is determined. By knowing the second near-field beam diameter 36 and knowing or assuming the divergence angle 44, the focal position 18 can be determined, for example.

In addition, the calculation of the Rayleigh length and/or the diffraction index can be determined by knowing or assuming the waist diameter 20 and/or by knowing or assuming the divergence angle 44.

By knowing the beam propagation parameters, the propagation of the laser beam 14, or the beam caustic 12, can be precisely determined or predicted.

In a subsequent method step 46 of the adjustment method 10, it is provided to ascertain a laser beam deviation. The laser beam deviation can consist of a deviation of one or more beam propagation parameters of the laser beam 14 from target beam propagation parameters of a target beam caustic 48 (see FIG. 2). In other words, a comparison of the beam caustic 12 with the target beam caustic 48 of the laser beam 14 is carried out.

In a further method step 50, it is provided to adjust the laser beam unit 22, in particular an optical device 52 (see FIGS. 2 and 3). The adjustment is carried out on the basis of the ascertained laser beam deviation. In other words, if the deviation of individual or multiple beam propagation parameters from predetermined target beam propagation parameters is known, an accurate and targeted adjustment can be made to the laser beam unit 22, in particular to the optical device 52.

FIG. 2 shows a laser beam unit 22 in a schematic representation.

The laser beam unit 22 has a laser beam generator 54. The laser beam generator 54 is designed to generate the laser beam 14. The laser beam generator 54 is located upstream of the optical device 52 in the laser beam propagation direction 16.

The optical device 52 is designed to output the laser beam 14. Preferably, the approximate formation of the beam caustic 12 of the laser beam 14 by the optical device 52 is known. In particular, with known approximate formation of the beam caustic 12, a near field and/or a far field of the laser beam 14 can be ascertained particularly quickly. This allows the adjustment method 10 (see FIG. 1) to be carried out particularly effectively and quickly.

In particular use of the laser beam unit 22, the optical device 52 is designed for irradiating a target material (not shown), in particular a tin droplet (not shown), in order to generate extreme ultraviolet radiation (EUV radiation).

As shown, the first measurement plane 30 is spaced apart from the second measurement plane 34 by a near-field measurement plane distance 56. In other words, the second near-field beam diameter 36 is determined to be spaced apart from the first near-field beam diameter 32 in the laser beam propagation direction 16. In this way, inaccuracies resulting from an insufficient near-field measurement plane distance 56 can be avoided when determining the beam caustic 12.

Preferably, the first measurement plane 30 is positioned in front of the focal position 18 in the laser beam propagation direction 16, as shown. In other words, the first measurement plane 30 is positioned in a tapering region of the laser beam 14. This allows for a particularly precise determination of the beam caustic 12.

Further preferably, it can be provided that the second measurement plane 34, as shown, is positioned behind the focal position 18 in the laser beam propagation direction 16. This allows the beam caustic 12 to be determined even more precisely.

FIG. 3 shows a laser beam unit 22 with an adjustment system 58 arranged thereon in a schematic representation.

The adjustment system 58 is designed to adjust the optical device 52 of the laser beam unit 22. Preferably, the adjustment system 58 is designed to adjust the optical device 52 using an approximately known beam caustic 12. The adjustment system 58 is configured to determine multiple, here three, beam diameters 26 along the laser beam propagation direction 16 of the laser beam 14.

Typically, the beam diameters 26 are determined using graphical representations 60 of the laser beam 14. The graphical representations 60 are preferably processed by one or more image-producing apparatuses 62, 64, 66, for example cameras and/or image sensors. The image-producing apparatuses 62, 64, 66 are designed for detecting a beam cross-section 67 of the laser beam 14 directly or indirectly. For reasons of clarity, only one beam cross-section 67 is provided with a reference sign. In other words, the image-producing apparatuses 62, 64, 66 can be positioned directly at the measurement planes 28 in the beam path of the laser beam 14. As shown, the image-producing apparatus 66 is positioned directly at the measurement plane 28. Alternatively, it can be provided that the image-producing apparatuses 62, 64, 66 detect a beam cross-section 67 of the laser beam 14 reflected at the measurement plane 28. As shown, the image-producing apparatuses 62, 64 are designed for detecting the beam cross-section 67 indirectly by reflecting the laser beam 14 via partially transparent mirrors or beam splitters 68. Indirect detection allows for parallel operation of the laser beam unit 22.

The image-producing apparatuses 62, 64, 66 can be arranged or positioned on the laser beam unit 22 in a stationary manner. As shown, the image-producing apparatuses 62, 64 are arranged or positioned on the laser beam unit 22 or on the beam path of the laser beam 14 in a stationary manner. As shown, the image-producing apparatus 66 is designed for temporary arrangement in the beam path of the laser beam 14.

A stationary arrangement eliminates the need for complex installation of the image-producing apparatuses 62, 64, 66 for detecting the beam diameters 26. This means that the adjustment method 10 (see FIG. 1) can be carried out particularly quickly. The stationary apparatuses 62, 64 can remain arranged on the laser beam unit 22 during operation of the laser beam unit 22.

It is preferred to use stationary image-producing apparatuses 62, 64 in regions of the laser beam unit 22 that are difficult to access, which results in considerable time advantages due to the elimination of setup and teardown times for detecting the beam diameters 26.

Particularly preferably, all image-producing apparatuses 62, 64, 66 are positioned at the laser beam unit 22 in a stationary manner. This allows the adjustment method 10 to be carried out while the laser beam unit 22 is in operation. This enables high frequency monitoring, in particular real-time monitoring of the beam caustic 12. By means of continuous monitoring, wear of components of the laser beam unit 22, in particular of the optical device 52, can be monitored and a maintenance interval can be adjusted. This can further increase the effectiveness of the laser beam unit 22.

As shown, it can be provided that an apparatus lens 69 is located upstream of one of the image-producing apparatuses 62, 64, 66—here the image-producing apparatus 66—in the laser beam propagation direction 16. In other words, as shown, the image-producing apparatus 66 and the apparatus lens 69 are arranged in the far field of the laser beam 14. Preferably, the apparatus lens 69 is positioned in the laser beam 14 together with the image-producing apparatus 66.

The apparatus lens 69 is typically designed as a converging lens with a predetermined or known focal length 70. The apparatus lens 69 is typically located upstream of the image-producing apparatus 66 by the focal length 70. This makes it particularly easy to determine the divergence angle 44 (see FIG. 2) on the basis of the beam diameter 26 and the focal length 70.

The adjustment system 58 further includes a computing unit 71. The computing unit 71 is designed and configured to determine the beam caustic 12 from the detected beam diameters 26. Furthermore, the computing unit 71 is designed and configured to determine deviations of the beam propagation parameters from target beam propagation parameters by comparing the beam caustic 12 with a target beam caustic 48 (see FIG. 2).

Preferably, the computing unit 71 is also designed to determine the beam diameters 26 from the graphical representation 60. The computing unit 71 can use graphical evaluation algorithms for this purpose, for example.

The adjustment system 58 further includes an output unit 72. The output unit 72 is designed to output the determined laser beam deviation. The output can, for example, be provided by means of a display (not shown). Preferably, the output unit 72 is designed to output adjustment suggestions concerning the adjustment of the laser beam unit 22 or the optical device 52.

Particularly preferably, the adjustment system 58 is designed to exchange data with a control unit (not shown) of the laser beam unit 22. As a result, adjustments of the laser beam unit 22 can be carried out automatically by the adjustment system 58. This increases the degree of automation of the laser beam unit 22.

Alternatively or additionally, it can be provided that the adjustment method 10 described above and below and/or the adjustment system 58 described above and below is/are carried out or arranged on a measurement beam (not shown). The measurement beam is typically generated by reflecting a sub-beam from the laser beam 14. Typically, the measurement beam is to be understood as a copy of the laser beam 14. In this way, interference with the laser beam 14 or the operation of the laser beam unit 22 can be avoided.

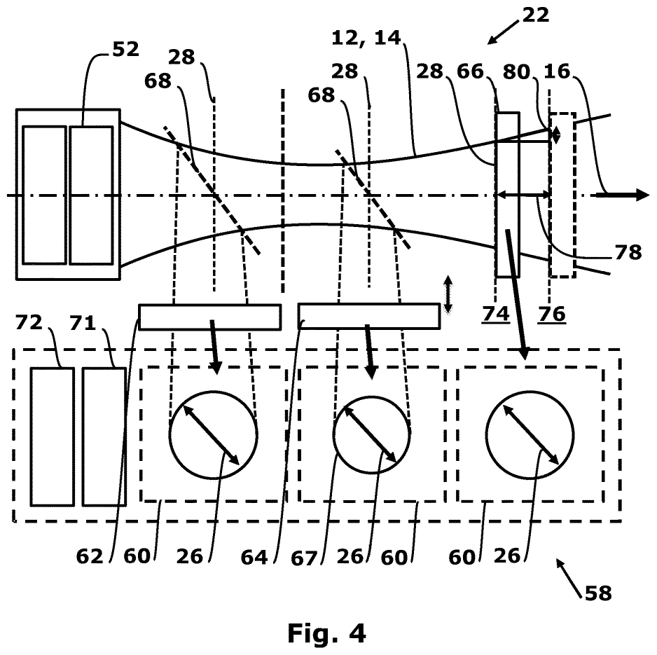

FIG. 4 shows a laser beam unit 22 with a further embodiment of the adjustment system 58 arranged thereon in a schematic representation.

The adjustment system 58 differs substantially from the adjustment system 58 of FIG. 3 by a modification of the image-producing apparatus 66 in the far field of the laser beam 14.

As shown, it can be provided that the image-producing apparatuses 62, 64, 66—here the image-producing apparatus 66—are arranged movably in the laser beam 14. In other words, at least a slight movement of the image-producing apparatus 66 may be provided. This makes it particularly easy, for example, to determine the divergence angle 44 (see FIG. 2) without using an apparatus lens 69 (see FIG. 3).

As shown, the image-producing apparatus 66 can be moved bidirectionally along the laser beam propagation direction 16 from a first measuring position 74 to a second measuring position 76. The second measuring position 76 is spaced apart from the first measuring position 74 by the predetermined travel path 78. The first measuring position 74 and the second measuring position 76 are positioned in the far field of the laser beam 14.

By comparing the beam diameters 26 of the measuring position 74 and the measuring position 76, a difference in diameter 80 can be ascertained. The divergence angle 44 can then be determined in a particularly simple way on the basis of the difference in diameter 80 and the travel path 78.

Alternatively, it can be provided that an auxiliary plane (not shown in more detail) is arranged at a distance of the travel path 78 from the first measuring position 74, or in the second measuring position 76. This means that the image-producing apparatus 66 does not need to be moved in order to ascertain the difference in diameter 80.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Adjustment method;
12 Beam caustic;
14 Laser beam;
16 Laser beam propagation direction;
18 Focal position;
20 Waist diameter;
22 Laser beam unit;
24 Method step;
26 Beam diameter;
28 Measurement plane;
30 First measurement plane;
32 First near-field beam diameter;
34 Second measurement plane;
36 Second near-field beam diameter;
38 Third measurement plane;
40 Far-field beam diameter;
42 Method step;
44 Divergence angle;
46 Method step;
48 Target beam caustic;
50 Method step;
52 Optical device;
54 Laser beam generator;
56 Near-field measurement plane distance;
58 Adjustment system;
60 Graphical representation;
62 Image-producing apparatus;
64 Image-producing apparatus;
66 Image-producing apparatus;
67 Beam cross-section;
68 Beam splitter;
69 Apparatus lens;
70 Focal length;
71 Computing unit;
72 Output unit;
74 First measuring position;
76 Second measuring position;
78 Travel path;
80 Difference in diameter.

1. A method for adjusting a beam caustic of a laser beam generated by a laser beam unit, the laser beam unit having an optical device, the method comprising:
a) ascertaining three beam diameters of the laser beam at three measurement planes positioned along a laser beam propagation direction;
b) determining the beam caustic of the laser beam by analytically calculating beam propagation parameters of the laser beam based on the three ascertained beam diameters;
c) ascertaining a laser beam deviation by comparing the beam caustic with a target beam caustic of the laser beam; and
d) adjusting the laser beam unit based on the ascertained laser beam deviation.

2. The method according to claim 1, wherein in step a) the three beam diameters comprise a far-field beam diameter of the laser beam ascertained at a third measurement plane of the three measurement planes, the third measurement plane being positioned in a far field of the laser beam, and wherein in step b) a divergence angle of the laser beam is determined based on the far-field beam diameter.

3. The method according to claim 2, wherein in step a) the three beam diameters comprise a first near-field beam diameter and a second near-field beam diameter ascertained at a first measurement plane and a second measurement plane, respective, of the three measurement planes, the first measurement plane and the second measurement plane being positioned in a near field of the laser beam, and wherein in step b) a focal position is determined.

4. The method according to claim 3, wherein in step b) a waist diameter is determined.

5. The method according to claim 4, wherein in step b) a Rayleigh length and/or a diffraction index is determined.

6. The method according to claim 3, wherein the first measurement plane and the second measurement plane are spaced apart from each other by a near-field measurement plane distance.

7. The method according to claim 3, wherein the first measurement plane is positioned in front of a focal position in the laser beam propagation direction.

8. The method according to claim 7, wherein the second measurement plane is positioned behind the focal position in the laser beam propagation direction.

9. The method according to claim 1, wherein at least one of the three beam diameters is determined by graphical evaluation of a graphical representation of a laser beam cross-section.

10. A system for adjusting an optical device of a laser beam unit by determining a plurality of beam diameters along a laser beam propagation direction of a laser beam by performing the method according to claim 1, the system comprising:
at least one image-producing apparatus for detecting the plurality of beam diameters of the laser beam, wherein the image-producing apparatus is configured to be at least temporary positioned in a beam path of the laser beam;
a computing unit for determining the beam caustic from the plurality of beam diameters and for determining a laser beam deviation by comparing the beam caustic with a target beam caustic; and
an output unit for outputting the determined laser beam deviation.

11. The system according to claim 10, wherein the at least one image-producing apparatus comprises two image-producing apparatuses, wherein at least one of the two image-producing apparatuses is configured to be positionable in a stationary manner on the beam path of the laser beam.

12. A laser beam unit with an optical device, the laser beam unit comprising the system according to claim 10.
